(19) United States
(12) Patent Application Publication
(10) Pub. No.: US 2024/0319941 A1
(43) Pub. Date: Sep. 26, 2024

(54) WIRELESS COMMUNICATION DEVICE, METHOD FOR CONTROLLING WIRELESS COMMUNICATION DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Taihei FUKUMOTO, SHIOJIRI-SHI (JP)

(21) Appl. No.: 18/612,776

(22) Filed: Mar. 21, 2024

(30) Foreign Application Priority Data
Mar. 24, 2023 (JP) 2023-047661

(51) Int. Cl. G06F 3/12

(52) U.S. Cl. CPC G06F 3/1292; G06F 3/1203; G06F 3/1236

(57) ABSTRACT

A wireless communication device includes: a first communication processor configured to perform processing of executing communication of a first wireless communication system; a target determination unit configured to determine whether a target device is present in a network accessible by the communication of the first wireless communication system; a second communication processor configured to perform processing of executing, when the target device is not present in the network, communication of a second wireless communication system with at least one of the target devices; and a transmission controller configured to perform control to transmit, to the at least one target device, setting information for participating in the network using the communication of the second wireless communication system.

The present application is based on, and claims priority from JP Application Serial Number 2023-047661, filed Mar. 24, 2023, the disclosure of which is hereby incorporated by reference herein in its entirety.

### BACKGROUND

### 1. Technical Field

The present disclosure relates to a wireless communication device, a method for controlling a wireless communication device, and a non-transitory computer-readable storage medium storing a program.

### 2. Related Art

A technique of printing using wireless communication is known. For example, JP-A-2018-19146 discloses a technique in which a terminal device and a printing device are connected to an access point by wireless communication, and data is transmitted from the terminal device to the printing device via the access point by the wireless communication, thereby implementing printing.

JP-A-2018-19146 is an example of the related art.

In the technique disclosed in JP-A-2018-19146, when the printing device is also connected to the access point to which the terminal device is connected, the terminal device can use a function of the printing device, but when the printing device is not connected to the access point, the terminal device cannot use the function of the printing device. That is, when the terminal device and the printing device are not present in the same network, the terminal device cannot use the function of the printing device by using wireless communication via the access point. Therefore, when a specific device is not present in a network, there is a demand for a technique for using a function of the specific device.

### SUMMARY

A wireless communication device according to the present disclosure includes: a first communication processing unit configured to perform processing of executing communication of a first wireless communication system; a target determination unit configured to determine whether a target device which is a device capable of providing a specific service is present in a network accessible by the communication of the first wireless communication system; a second communication processing unit configured to perform processing of executing, when the target device is not present in the network, communication of a second wireless communication system, which is a communication system according to an NAN standard and is different from the first wireless communication system, with at least one of the target devices; and a transmission control unit configured to perform control to transmit, to the at least one of the target devices, setting information for participating in the network using the communication of the second wireless communication system.

In a method for controlling a wireless communication device according to the present disclosure, the method includes: performing processing of executing communication of a first wireless communication system; determining whether a target device which is a device capable of providing a specific service is present in a network accessible by the communication of the first wireless communication system; performing processing of executing, when the target device is not present in the network, communication of a second wireless communication system, which is a communication system according to an NAN standard and is different from the first wireless communication system, with at least one of the target devices; and performing control to transmit, to the at least one of the target devices, setting information for participating in the network using the communication of the second wireless communication system.

A non-transitory computer-readable storage medium stores a program according to the present disclosure, the program causing a computer to execute: a first communication processing step of performing processing of executing communication of a first wireless communication system; a target determination step of determining whether a target device which is a device capable of providing a specific service is present in a network accessible by the communication of the first wireless communication system; a second communication processing step of performing processing of executing, when the target device is not present in the network, communication of a second wireless communication system, which is a communication system according to an NAN standard and is different from the first wireless communication system, with at least one of the target devices; and a transmission control step of performing control to transmit, to the at least one of target devices, setting information for participating in the network using the communication of the second wireless communication system.

### BRIEF DESCRIPTION OF THE DRAWINGS

FIG. 1 is a schematic diagram showing an example of a configuration of a communication system according to an embodiment.

FIG. 2 is a block diagram showing an example of a configuration of a wireless communication device according to the embodiment.

FIG. 3 is a block diagram showing an example of a configuration of a target device according to the embodiment.

FIG. 4 is a flowchart showing an example of an operation flow of the communication system for causing the target device to participate in a wireless LAN.

FIG. 5 is a schematic diagram showing an example of a user interface screen.

FIG. 6 is a schematic diagram showing transition of a connection state of each device in the communication system according to the embodiment.

### DESCRIPTION OF EMBODIMENTS

Hereinafter, an embodiment will be described with reference to the drawings. To clarify the description, the following description and drawings are omitted and simplified as appropriate. In the drawings, the same elements are denoted by the same reference signs, and the redundant description thereof is omitted as necessary.

As described above, when a specific device is not present in a network, there is a demand for a technique for using a function of the specific device. Therefore, in the embodiment, a technique will be described in which it is determined whether a specific device is present in a network, and when the specific device is not present, the specific device can participate in the network.

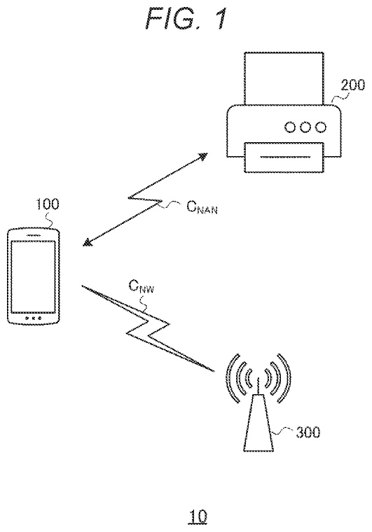

FIG. 1 is a schematic diagram showing an example of a configuration of a communication system 10 according to the embodiment. The communication system 10 includes a wireless communication device 100, a target device 200, and an access point 300. The access point 300 is an access point of a wireless local area network (LAN). Specifically, the wireless LAN is, for example, a Wi-Fi (registered trademark) network. In the embodiment, the wireless communication device 100 is a device using the target device 200. The target device 200 is a wireless communication device capable of providing a specific service, and is a device used for the wireless communication device 100. In FIG. 1, one target device 200 is provided, and the communication system 10 may include a plurality of target devices 200.

In Wi-Fi Aware which is one of Wi-Fi Alliance certification programs, a communication protocol called a neighbor awareness network (NAN), which wirelessly communicates between devices without using an access point, is defined. Hereinafter, a standard for the NAN defined by Wi-Fi Alliance is referred to as an NAN standard. In the embodiment, the wireless communication device 100 transmits setting information to be described later to the target device 200 by communication according to the NAN standard, thereby causing the target device 200 to participate in the wireless LAN using the access point 300.

In the present disclosure, a wireless communication system for performing communication via the access point 300 is also referred to as a network (NW) wireless communication system. The NW wireless communication system can be referred to as a system for performing communication via the access point 300 according to a Wi-Fi (registered trademark) standard, or can be referred to as an infrastructure mode wireless communication system. In the present disclosure, a communication system according to the NAN standard is also referred to as an NAN wireless communication system. FIG. 1 shows a state in which the wireless communication device 100 can execute communication C_{NW} of the NW wireless communication system. In the state shown in FIG. 1, the wireless communication connection of the NW wireless communication system is not yet established, and the target device 200 cannot execute the communication of the NW wireless communication system. Therefore, as described later, the wireless communication device 100 transmits the setting information to the target device 200 by communication C_{NAN} of the NAN wireless communication system.

In the embodiment, the wireless communication device 100 is, for example, a terminal device. Specifically, the wireless communication device 100 is, for example, a mobile terminal such as a smartphone or a tablet terminal. The wireless communication device 100 is not limited thereto, and may be a personal computer (PC) or the like. In the embodiment, the target device 200 is, for example, a printing device (printer). In the communication system 10, the wireless communication device 100 and the target device 200 perform communication of the NAN wireless communication system, that is, communication according to the NAN standard as described above.

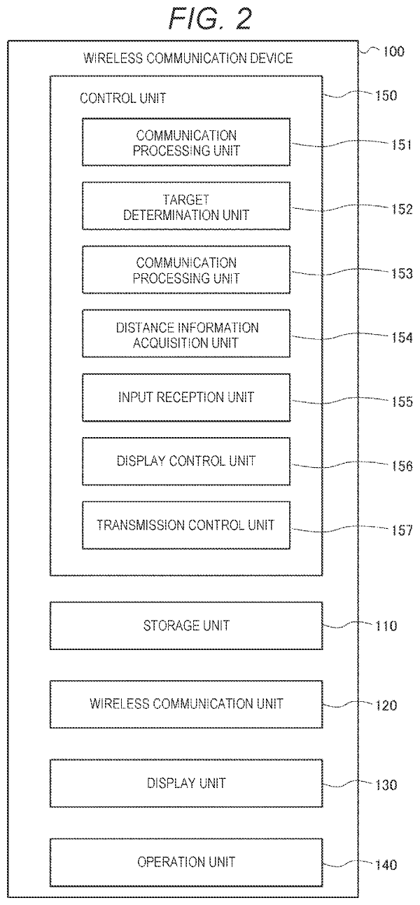

Hereinafter, specific configurations and processing of the wireless communication device 100 and the target device 200 will be described. First, the wireless communication device 100 will be described. FIG. 2 is a block diagram showing an example of the configuration of the wireless communication device 100. As shown in FIG. 2, the wireless communication device 100 includes a storage unit 110, a wireless communication unit 120, a display unit 130, an operation unit 140, and a control unit 150.

The storage unit 110 is a storage device that stores a program for implementing processing of the control unit 150 and data used for processing of the wireless communication device 100. The storage device may be a nonvolatile storage device such as a hard disk or a flash memory, or may include a memory such as a random access memory (RAM).

The wireless communication unit 120 is hardware that performs wireless communication. That is, the wireless communication unit 120 is a wireless communication interface. The wireless communication unit 120 may include a transmission circuit, a reception circuit, and an antenna.

The display unit 130 and the operation unit 140 are user interfaces. The display unit 130 is implemented by a display or the like that displays various types of information to the user. The operation unit 140 is implemented by a button or the like that receives an input operation from the user. The display unit 130 and the operation unit 140 may be integrally implemented by a touch panel or the like.

The control unit 150 is a processor such as a central processing unit (CPU) that controls each configuration of the wireless communication device 100. The control unit 150 may include a plurality of processors. The control unit 150 reads a program into the memory and executes the program. Accordingly, in the embodiment, the control unit 150 implements functions of a communication processing unit 151, a target determination unit 152, a communication processing unit 153, a distance information acquisition unit 154, an input reception unit 155, a display control unit 156, and a transmission control unit 157. The wireless communication device 100 includes the communication processing unit 151 and the communication processing unit 153, and has a configuration capable of performing communication in two types of different wireless communication systems.

The communication processing unit 151 performs processing of executing communication of the NW wireless communication system. The processing includes processing of establishing a wireless communication connection of the NW wireless communication system using setting information. The setting information is information necessary for establishing the wireless communication connection of the NW wireless communication system, that is, information for connecting to the wireless LAN. In the embodiment, specifically, the setting information is a service set identifier (SSID) and a password of the access point 300. The communication of the NW wireless communication system is performed after a wireless communication connection is established using such setting information.

The target determination unit 152 determines whether the target device 200 is present in a network accessible by the wireless communication device 100 through the communication of the NW wireless communication system. More specifically, the target determination unit 152 determines whether there are one or more target devices 200 in the network. Accordingly, the target determination unit 152 determines whether the target device 200 is participating in the wireless LAN which is a network used for communication via the access point 300.

In the embodiment, as an example, the target determination unit 152 determines whether the target device 200 is participating in the wireless LAN based on whether the wireless communication device 100 receives a predetermined packet from the target device 200 by the communication of the NW wireless communication system. When the wireless communication device 100 cannot receive the predetermined packet from the target device 200 by the communication of the NW wireless communication system, the target determination unit 152 determines that the target device 200 does not participate in the wireless LAN. The target determination unit 152 may perform the following processing in order to obtain the packet from the target device 200. For example, the target determination unit 152 may broadcast a packet for searching for the target device 200 to each device connected to the wireless LAN (access point 300) using the communication of the NW wireless communication system. Then, when the wireless communication device 100 receives, by the communication of the NW wireless communication system, a response packet from the target device 200 that received the packet, the target determination unit 152 determines that the target device 200 is present in the wireless LAN. In contrast, when the wireless communication device 100 cannot receive the response packet, the target determination unit 152 determines that the target device 200 is not present in the wireless LAN. The above-described predetermined packet transmitted from the target device 200 is a packet for notifying another device present in the wireless LAN that the target device 200 is present in the wireless LAN. The target device 200 may transmit the packet as the above-described response packet, or may spontaneously transmit the packet. The spontaneous transmission of the predetermined packet performed by the target device 200 may be performed periodically. When the target device 200 spontaneously transmits the predetermined packet, the wireless communication device 100 may not broadcast the packet for searching for the target device 200.

The target determination unit 152 may further determine whether the target device 200 that received the setting information from the wireless communication device 100 successfully connects to the wireless LAN (access point 300). The target determination unit 152 determines whether the connection is successful by determining whether the wireless communication device 100 receives the packet from the target device 200 by the communication of the NW wireless communication system. The target determination unit 152 determines that the connection is successful when the wireless communication device 100 receives the packet from the target device 200 by the communication of the NW wireless communication system. In contrast, for example, when the network connection performed by the target device 200 cannot be confirmed even after a predetermined time elapses from the transmission of the setting information, the target determination unit 152 determines that the target device 200 fails in the network connection. That is, when the wireless communication device 100 cannot receive the packet from the target device 200 even after the predetermined time elapses from the transmission of the setting information, the target determination unit 152 determines that the target device 200 fails in the network connection. When the target determination unit 152 determines whether the target device 200 that received the setting information successfully connects to the wireless LAN, the target determination unit 152 may perform the following processing in order to obtain the packet from the target device 200. For example, the target determination unit 152 may broadcast a packet for searching for the target device 200 to each device connected to the wireless LAN (access point 300) using the communication of the NW wireless communication system. Then, when the wireless communication device 100 receives, by the communication of the NW wireless communication system, the response packet from the target device 200 that receives the packet, the target determination unit 152 determines that the target device 200 successfully connects to the wireless LAN. In contrast, when the wireless communication device 100 cannot receive the response packet, the target determination unit 152 determines that the target device 200 fails to connect to the wireless LAN. The above-described packet for searching for the target device 200 may be periodically transmitted, or may be transmitted at a predetermined timing after the transmission of the setting information.

Identity between a wireless communication device as a transmission destination of the setting information and a wireless communication device as a transmission source of the packet such as the above-described response packet can be determined by using, for example, a media access control (MAC) address notified during communication. In this case, the target determination unit 152 may store, in the storage unit 110, the MAC address of the wireless communication device (target device 200) as the transmission destination notified in the communication for transmitting the setting information. Then, the target determination unit 152 determines whether the connection of the target device 200 to the wireless LAN is successful by determining whether the MAC address notified by the communication of the NW wireless communication system matches the MAC address stored in the storage unit 210.

When the target determination unit 152 determines whether the target device 200 that received the setting information successfully connects to the wireless LAN, the wireless communication device 100 does not necessarily broadcast the packet for searching for the target device 200. For example, when the target device 200 establishes the wireless communication connection of the NW wireless communication system, the target device 200 may broadcast the packet to each device connected to the wireless LAN (access point 300) using the communication of the NW wireless communication system. In this case, the wireless communication device 100 does not need to broadcast the packet for searching for the target device 200. The broadcast of the packet performed by the target device 200 that establishes the wireless communication connection of the NW wireless communication system may be performed at a time when the wireless communication connection is established, or may be performed periodically.

The communication processing unit 153 performs processing of executing the communication of the NAN wireless communication system with at least one of target devices 200. In particular, in the embodiment, when the target device 200 is not present in the network (that is, the wireless LAN) accessible by the wireless communication device 100 through the communication of the NW wireless communication system, the communication processing unit 153 performs the processing of executing the communication of the NAN wireless communication system with the at least one of target devices 200. The wireless communication device 100 and the target device 200 can perform two types of communication, that is, communication using a discovery window (DW) according to the NAN standard and communication performed after establishing the wireless communication connection according to the NAN standard, as the communication of the NAN wireless communication system. Therefore, the processing performed by the communication processing unit 153 includes processing of executing the communication using the discovery window and processing of executing the communication performed after establishing the wireless communication connection. Hereinafter, the wireless communication connection according to the NAN standard is also referred to as an NAN connection. Here, in the embodiment, the wireless communication connection according to the NAN standard is specifically an NAN data link. As described later, the communication processing unit 153 searches for the at least one of target devices 200 according to the NAN standard, and establishes an NAN connection (NAN data link), which is a wireless communication connection of the NAN wireless communication system, with the at least one of target devices 200.

Here, processing of the communication processing unit 151 and a communication processing unit 241 of the target device 200, which will be described later, for establishing an NAN connection between the wireless communication device 100 and the target device 200 will be described in detail. The communication processing unit 241 is a component of the target device 200 that performs processing of executing the communication of the NAN wireless communication system. The communication processing unit 151 and the communication processing unit 241 of the target device 200 to be described later establish an NAN connection according to a connection sequence defined by the NAN standard.

In order to establish the NAN connection, first, the communication processing unit 153 of the wireless communication device 100 and the communication processing unit 241 of the target device 200 perform processing for implementing an NAN cluster by the wireless communication device 100 and the target device 200. Thereafter, the communication processing unit 153 of the wireless communication device 100 and the communication processing unit 241 of the target device 200 perform processing of constructing the NAN connection, that is, the NAN data link.

In the NAN standard, a period called a discovery window is defined. The discovery window is mainly a communication period that occurs intermittently for the device to perform service notification and search, and arrives at a predetermined cycle. A set of devices sharing the discovery window is called an NAN cluster. A device operating as a master transmits a discovery beacon for recognizing the NAN cluster to another device that does not yet belong to the NAN cluster. The device operating as the master transmits a synchronization beacon for each device to synchronize with the discovery window. In the embodiment, the wireless communication device 100 may operate as a master, or the target device 200 may operate as a master.

Each device implementing the NAN cluster can confirm a service provided by each device by transmitting and receiving a signal in the discovery window. Specifically, in the discovery window, a signal implemented by a frame of a format called a service discovery frame is transmitted.

A device implementing an NAN cluster can establish a data link capable of intercommunicating with another device implementing the NAN cluster regardless of a DW period. That is, the NAN connection can be established between devices implementing the NAN cluster. In the NAN standard, the above-described data link is called an NAN data link. Hereinafter, a flow until the wireless communication device 100 and the target device 200 perform the NAN connection in the embodiment will be described.

First, the wireless communication device 100 and the target device 200 share the discovery window. In order to share the discovery window, either the wireless communication device 100 or the target device 200 operates as a master. For example, when the wireless communication device 100 operates as a master, the communication processing unit 153 of the wireless communication device 100 performs processing of transmitting a discovery beacon and a synchronization beacon from the wireless communication device 100.

When the wireless communication device 100 and the target device 200 share the discovery window, the target device 200 waits for an inquiry about a service to be broadcast. Then, the communication processing unit 153 of the wireless communication device 100 performs communication using the discovery window in order to search for the target device 200 which is a device providing a specific service (in the embodiment, for example, a printing service). Specifically, the communication processing unit 153 broadcasts the inquiry about the service by transmitting a signal using the discovery window defined in the NAN standard. That is, the communication processing unit 153 broadcasts a message for making an inquiry to all other devices implementing the NAN cluster. The message is a message using the service discovery frame. In response, the communication processing unit 241 of the target device 200 that received the broadcast of the inquiry responds to the inquiry by transmitting a signal using the discovery window defined by the NAN standard. Accordingly, the wireless communication device 100 can specify a device capable of providing the specific service. Thereafter, the communication processing unit 153 of the wireless communication device 100 and the communication processing unit 241 of the target device 200 execute processing of establishing the NAN data link according to a connection procedure according to the NAN standard. Accordingly, the NAN connection is established.

Next, another processing of the communication processing unit 153 of the wireless communication device 100 will be described. When the transmission of the setting information based on the control of the transmission control unit 157 to be described later is completed, the communication processing unit 153 separates from the NAN cluster. That is, when the transmission of the setting information is completed, the communication processing unit 153 separates the wireless communication device 100 from the NAN cluster to which the wireless communication device 100 belongs in order to transmit the setting information by the communication of the NAN wireless communication system. When the transmission destination of the setting information is the plurality of target devices 200, the communication processing unit 153 separates from the NAN cluster when the transmission of the setting information to all of the target devices 200 belonging to the same NAN cluster is completed. Here, the separation from the NAN cluster specifically refers to disconnecting of the NAN connection and ending of NAN synchronization. The NAN synchronization is processing of synchronizing with the discovery window. However, when the NAN connection is not established by the wireless communication device 100, the separation from the NAN cluster means only the ending of the NAN synchronization. Power consumption can be reduced due to the separation from the NAN cluster. When a common antenna is used in the communication of the NW wireless communication system and the communication of the NAN wireless communication system, it is possible to improve throughput of the communication of the NW wireless communication system by separating the wireless communication device 100 from the NAN cluster.

The communication processing unit 153 may separate the wireless communication device 100 from the NAN cluster when the target device 200 as the transmission destination of the setting information successfully establishes the wireless communication connection of the NW wireless communication system. That is, the communication processing unit 153 may separate the wireless communication device 100 from the NAN cluster after the target device 200 that received the setting information participates in the wireless LAN (access point 300). When the setting information is transmitted to the plurality of target devices 200, the communication processing unit 153 may separate the wireless communication device 100 from the NAN cluster when all of the target devices 200 belonging to the same NAN cluster, which are the transmission destinations of the setting information, successfully establish the wireless communication connection of the NW wireless communication system.

The distance information acquisition unit 154 acquires, for each target device 200 found by a search according to the NAN standard, distance information indicating a distance to the wireless communication device 100. That is, the distance information acquisition unit 154 acquires information indicating a distance between the wireless communication device 100 and another wireless communication device (target device 200) belonging to the NAN cluster to which the wireless communication device 100 belongs. In the embodiment, the distance information acquisition unit 154 acquires the distance information indicating the distance to the wireless communication device 100 measured according to the NAN standard. The NAN standard defines a technique in which a device implementing an NAN cluster measures a distance between the device and another device implementing the NAN cluster. The technique is also called Ranging. In Ranging, a predetermined frame is transmitted and received between the devices implementing the NAN cluster, and a distance between the devices is calculated based on a transmission and reception time of the predetermined frame. The distance information acquisition unit 154 acquires the distance between the wireless communication device 100 and the target device 200 measured using the technique. The distance information acquisition unit 154 may acquire the distance information indicating the distance measured by the wireless communication device 100, or may acquire, from the target device 200, information indicating a distance measured by the target device 200. In the embodiment, the distance information acquisition unit 154 acquires the distance measured according to the NAN standard, and may acquire a distance measured according to another technique. In this case, the distance information acquired by the distance information acquisition unit 154 may be information indicating the distance measured by the wireless communication device 100 or information indicating a distance received from another device.

The input reception unit 155 receives an instruction or information input by the user via the operation unit 140. In the embodiment, for example, the input reception unit 155 receives a printing instruction given by the user via the operation unit 140. The instruction includes an instruction to designate data to be printed. The instruction may further include an instruction to designate a print setting. The input reception unit 155 receives an instruction as to whether to connect the target device 200 to the wireless LAN. The input reception unit 155 may receive an instruction to select the target device 200 to be connected to the wireless LAN. That is, the input reception unit 155 may receive an instruction to select the target device 200 as the transmission destination of the setting information for connecting to the wireless LAN.

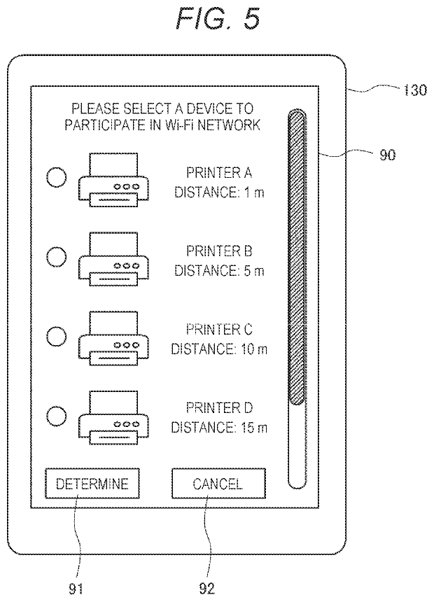

The display control unit 156 controls display performed by the display unit 130. In the embodiment, the display control unit 156 displays, on the display unit 130, a user interface screen for determining the target device 200 as the transmission destination of the setting information as shown in FIG. 5 to be described later. That is, the display control unit 156 controls the display unit 130 to display a list of the target devices 200 found by a search according to the NAN standard. In particular, the display control unit 156 controls the display unit 130 to display distance information for each target device 200 acquired by the distance information acquisition unit 154. That is, the display control unit 156 performs control such that the distance information for each target device 200 is also displayed in the list described above. Accordingly, the user can select the target device 200 to be connected to the wireless LAN by referring to the distance. Therefore, convenience for the user is improved.

The transmission control unit 157 performs control to transmit setting information necessary for establishing the wireless communication connection of the NW wireless communication system to the at least one of target devices 200 found by a search according to the NAN standard, by using the wireless communication connection of the NAN wireless communication system established by the communication processing unit 153, that is, the NAN connection. Accordingly, in the embodiment, the setting information (the SSID and the password of the access point 300) is transmitted to the target device 200. When the target device 200 as the transmission destination of the setting information fails to establish the wireless communication connection of the NW wireless communication system after the transmission of the setting information, the transmission control unit 157 may perform control to transmit the setting information to the target device 200 again using the NAN connection. That is, when the target device 200 that received the setting information fails to connect to the wireless LAN (access point 300), the wireless communication device 100 may transmit the setting information to the target device 200 again. Accordingly, by performing the retransmission of the setting information, it is possible to appropriately transmit the setting information even when an error occurs in the first transmission of the setting information. That is, even when a bit error occurs due to an influence of noise or the like during the transmission of the setting information, since the setting information is retransmitted to the target device 200, the target device 200 can receive correct setting information. In particular, when the separation of the wireless communication device 100 from the NAN cluster is performed when the target device 200 successfully establishes the wireless communication connection of the NW wireless communication system, even when the retransmission of the setting information is necessary, it is not necessary to perform processing of constructing the NAN cluster again or establishing the NAN connection again. Therefore, the setting information can be immediately retransmitted. The transmission control unit 157 may transmit, to the target device 200, the setting information and a request for instructing execution of connection processing using the setting information.

The transmission control unit 157 may limit, based on the distance information acquired by the distance information acquisition unit 154, a transmission destination of the setting information necessary for establishing the wireless communication connection of the NW wireless communication system. For example, the transmission control unit 157 may perform control to transmit the setting information only to the target device 200 existing within a predetermined distance from the wireless communication device 100. Accordingly, it is possible to prevent the setting information from being transmitted to the target device 200 located at a far position, and thus it is possible to prevent the setting information from leaking to the target device 200 which is not managed by the user. According to the above-described configuration, since the setting information is transmitted to the target device 200 which is closest to the user of the wireless communication device 100, it is possible to implement printing via the wireless LAN by a device closest to the user.

The transmission control unit 157 may determine a transmission destination of the setting information according to an instruction to select the transmission destination from the target devices 200 listed in the above-described list displayed by the display control unit 156. In this case, the transmission control unit 157 determines the transmission destination of the setting information according to the instruction from the user received by the input reception unit 155. According to such a configuration, the user can select a transmission destination of the setting information from the list. That is, the user can select the target device 200 to be connected to the wireless LAN. Therefore, convenience for the user is improved.

The transmission control unit 157 may control transmission of information other than the setting information. For example, the transmission control unit 157 may perform control to transmit a print job generated according to a printing instruction received by the input reception unit 155 to the target device 200 using the wireless communication connection of the NW wireless communication system. In the embodiment, when the target device 200 is not participating in the wireless LAN, the wireless communication device 100 transmits, to the target device 200, the setting information for connecting to the wireless LAN to connect the target device 200 to the wireless LAN. Therefore, in the embodiment, regardless of whether the target device 200 is participating in the wireless LAN in advance, the transmission control unit 157 can transmit the print job to the target device 200 using the wireless communication connection of the NW wireless communication system. The transmission control unit 157 may perform control to transmit the print job generated according to the printing instruction received by the input reception unit 155 to the target device 200 using the wireless communication connection of the NAN wireless communication system. The transmission control unit 157 may perform control to switch the wireless communication connection between the NW wireless communication system and the NAN wireless communication system according to the throughput, and to transmit the print job. In particular, when the target device 200 that received the setting information fails to establish the wireless communication connection of the NW wireless communication system, the transmission control unit 157 may perform control to transmit the print job to the target device 200 using the wireless communication connection of the NAN wireless communication system. According to such a configuration, even when the wireless communication device 100 and the target device 200 cannot perform communication of the NW wireless communication system, printing can be implemented.

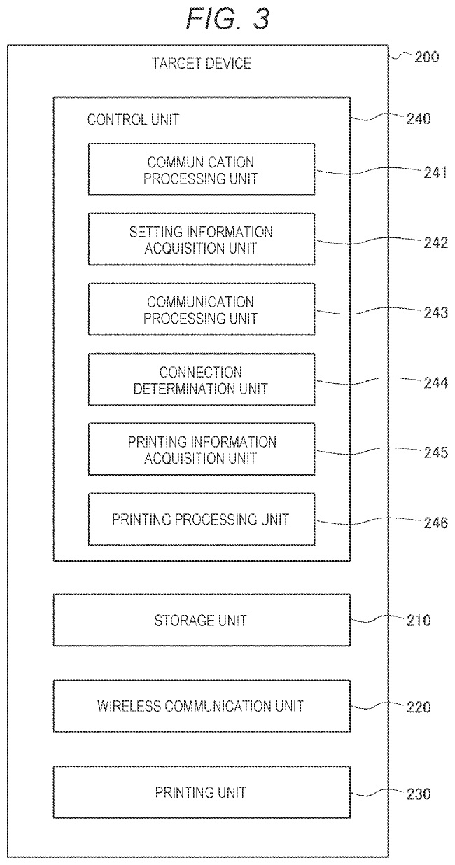

Next, the target device 200 will be described. FIG. 3 is a block diagram showing an example of a configuration of the target device 200. As shown in FIG. 3, the target device 200 includes the storage unit 210, a wireless communication unit 220, a printing unit 230, and a control unit 240. The target device 200 may include other components. For example, the target device 200 may further include a user interface such as a touch panel display, or may further include a scanner.

The storage unit 210 is a storage device that stores a program for implementing processing of the control unit 240 and data used for processing of the target device 200. The storage device may be a nonvolatile storage device such as a hard disk or a flash memory, and may include a memory such as an RAM.

The wireless communication unit 220 is hardware that performs wireless communication. That is, the wireless communication unit 220 is a wireless communication interface. The wireless communication unit 220 may include a transmission circuit, a reception circuit, and an antenna.

The printing unit 230 has a printing function for printing on a printing medium such as a sheet. The printing unit 230 includes a printing engine. The printing engine is a mechanical configuration that prints an image on the printing medium using a color material. The printing engine may include a mechanism for printing using ink by, for example, an inkjet method. Alternatively, the printing engine may include a mechanism for printing using toner by, for example, electrophotography. The printing engine may include a transport mechanism for transporting the printing medium.

The control unit 240 is a processor such as a CPU that controls each configuration of the target device 200. The control unit 240 may include a plurality of processors. The control unit 240 reads a program into the memory and executes the program. Accordingly, in the embodiment, the control unit 240 implements functions of the communication processing unit 241, a setting information acquisition unit 242, a communication processing unit 243, a connection determination unit 244, a printing information acquisition unit 245, and a printing processing unit 246.

The target device 200 includes the communication processing unit 241 and the communication processing unit 243, and has a configuration capable of performing communication in two types of different wireless communication systems.

The communication processing unit 241 performs processing of executing communication of the NAN wireless communication system with another wireless communication device (in the embodiment, the wireless communication device 100). As described above, the wireless communication device 100 and the target device 200 can perform two types of communication, that is, communication using the discovery window and communication performed after establishing an NAN connection, as communication of the NAN wireless communication system. Therefore, the processing performed by the communication processing unit 241 includes processing of executing the communication using the discovery window and processing of executing the communication performed after establishing the NAN connection. As described above, in the embodiment, the communication processing unit 241 performs the communication with the wireless communication device 100 using the discovery window to establish an NAN connection with the wireless communication device 100.

When the setting information acquisition unit 242 to be described later acquires the setting information from the wireless communication device 100, the communication processing unit 241 separates from the NAN cluster. That is, when the reception of the setting information is completed, the communication processing unit 241 separates the target device 200 from the NAN cluster to which the target device 200 belongs in order to receive the setting information by the communication of the NAN wireless communication system. When the target device 200 successfully establishes the wireless communication connection of the NW wireless communication system, the communication processing unit 241 may separate the target device 200 from the NAN cluster. That is, the communication processing unit 241 may separate from the NAN cluster when connection processing performed by the communication processing unit 243 to be described later using the setting information received from the wireless communication device 100 is successful. In other words, the communication processing unit 241 may separate the target device 200 from the NAN cluster after the target device 200 successfully connects to the wireless LAN (access point 300).

The setting information acquisition unit 242 acquires setting information from the wireless communication device 100 using the wireless communication connection of the NAN wireless communication system established by the communication processing unit 241, that is, the NAN connection.

The communication processing unit 243 performs processing of executing communication of the NW wireless communication system. The communication processing unit 243 establishes a wireless communication connection of the NW wireless communication system using the setting information acquired by the setting information acquisition unit 242, that is, the setting information received from the wireless communication device 100. Specifically, the communication processing unit 243 establishes the wireless communication connection of the NW wireless communication system using the SSID and the password of the access point 300 received from the wireless communication device 100. When the wireless communication connection of the NW wireless communication system is successfully established, the communication processing unit 241 disconnects the NAN connection as described above.

The connection determination unit 244 determines whether the target device 200 establishes the wireless communication connection of the NW wireless communication system. That is, the connection determination unit 244 determines whether the target device 200 successfully connects to the wireless LAN (access point 300).

The printing information acquisition unit 245 acquires a print job from the wireless communication device 100 using the wireless communication connection of the NW wireless communication system established by the communication processing unit 243. The printing information acquisition unit 245 may acquire a print job from the wireless communication device 100 using the NAN connection established by the communication processing unit 241.

The printing processing unit 246 performs processing for executing printing by the printing unit 230. In the embodiment, the printing processing unit 246 executes, using the printing unit 230, printing according to the print job received from the wireless communication device 100.

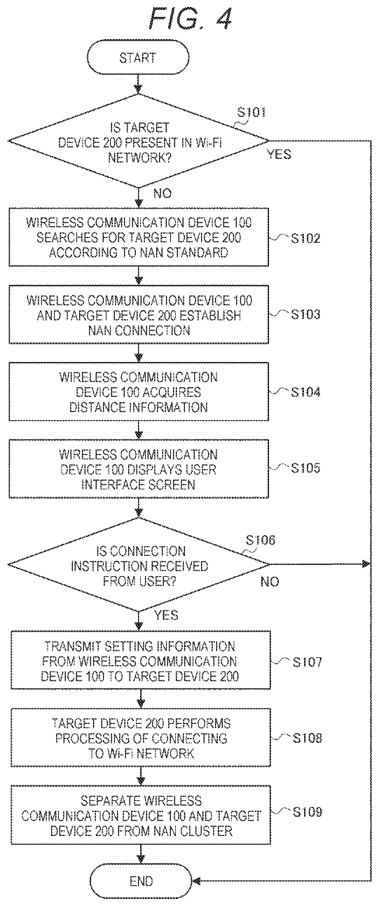

Next, in the embodiment, an operation flow of the communication system 10 for causing the target device 200 to participate in the wireless LAN will be described. FIG. 4 is a flowchart showing an example of the operation flow of the communication system 10 for causing the target device 200 to participate in the wireless LAN in the embodiment. The flowchart shown in FIG. 4 merely shows an example of the operation. Accordingly, for example, an execution order of steps can be changed as long as there is no technical contradiction. Some of the steps may be omitted. Prior to the operation described below, the wireless communication device 100 establishes the wireless communication connection of the NW wireless communication system using the setting information. On the other hand, it is assumed that the target device 200 has not yet established the wireless communication connection of the NW wireless communication system. Hereinafter, the operation flow will be described with reference to FIG. 4.

Step S101 may be executed, for example, when the user activates predetermined application software (for example, a printing application) installed in the wireless communication device 100. A trigger of step S101 is not limited thereto. In step S101, the target determination unit 152 of the wireless communication device 100 determines whether the target device 200 is connected to a wireless LAN (specifically, the Wi-Fi (registered trademark) network in the embodiment). That is, the target determination unit 152 determines whether the target device 200 is present in the wireless LAN. Here, the description is continued assuming that the target device 200 is not connected to the wireless LAN. However, when the target device 200 is connected to the wireless LAN, the processing ends. When the target device 200 is not connected to the wireless LAN, the processing proceeds to step S102.

In step S102, the communication processing unit 153 of the wireless communication device 100 searches for the target device 200 according to the NAN standard by broadcasting an inquiry about a service. That is, the communication processing unit 153 performs communication using a discovery window, and searches for the target device 200. At this time, the communication processing unit 153 may search for only a wireless communication device capable of providing a specific service according to the NAN standard by broadcasting the inquiry about the service. In this case, in the subsequent step, the setting information is transmitted only to the wireless communication device capable of providing the specific service. Accordingly, it is possible to search for only a wireless communication device appropriate for participation in the wireless LAN. For example, the communication processing unit 153 may search for a device capable of providing a connection service such as the target device 200, that is, only a wireless communication device having a function of establishing the wireless communication connection of the NW wireless communication system using the setting information received by the NAN connection. For example, the communication processing unit 153 may search for only a wireless communication device capable of providing a printing service, or may search for only a wireless communication device capable of providing a scan service. The communication processing unit 153 may search for only a wireless communication device capable of providing a specific service satisfying a specific condition. For example, the communication processing unit 153 may search for only a wireless communication device capable of providing a printing service with a specific print setting.

Then, in the embodiment, in step S103, the communication processing unit 153 of the wireless communication device 100 establishes an NAN connection with the target device 200 searched for in step S102. In other words, the communication processing unit 241 of the target device 200 establishes the NAN connection with the wireless communication device 100. When the plurality of target devices 200 are found in the search in step S102, the communication processing unit 153 of the wireless communication device 100 may establish an NAN connection with the plurality of target devices 200.

In step S104, the distance information acquisition unit 154 of the wireless communication device 100 acquires a distance between the wireless communication device 100 and the target device 200 for which the NAN connection is established in step S103.

Next, in step S105, the display control unit 156 of the wireless communication device 100 displays, on the display unit 130, a user interface screen for determining the target device 200 as the transmission destination of the setting information. Specifically, for example, as shown in FIG. 5, the display control unit 156 displays, on the display unit 130, a user interface screen 90 including a list of the target devices 200 found by the search in step S102. That is, the display control unit 156 displays, on the display unit 130, a list in which candidates of the target device 200 as the transmission destination of the setting information are shown.

FIG. 5 is a schematic diagram showing an example of the user interface screen 90 displayed by the display control unit 156. As shown in FIG. 5, the display control unit 156 may display, for each candidate as the transmission destination of the setting information, a distance from the wireless communication device 100. As shown in FIG. 5, the display control unit 156 may display identification information (printer name) on each target device 200. In order to acquire the identification information on each target device 200, an inquiry about the identification information may be made to the NAN connected target device 200. The user interface screen 90 shown in FIG. 5 includes a button 91 for instructing transmission of the setting information stored by the wireless communication device 100 to the target device 200, and a button 92 for canceling the transmission of the setting information stored by the wireless communication device 100 to the target device 200. The button 91 can also be referred to as a button for instructing the target device 200 to newly participate in the wireless LAN. The button 92 can also be referred to as a button for canceling the target device 200 to newly participate in the wireless LAN. When the user causes the target device 200 to newly participate in the wireless LAN, the user selects a participation target device from the target devices 200 listed in the list, and presses the button 91. In the example shown in FIG. 5, the user interface screen 90 includes the list, but a user interface screen not including the list may be displayed. In this case, when the user causes the target device 200 to newly participate in the wireless LAN, the user instructs the target device 200 to newly participate in the wireless LAN without selecting the target device 200. In this case, the transmission control unit 157 may transmit the setting information to all the NAN connected target devices 200, or may determine the target device 200 as the transmission destination based on the distance information as described above.

When the input reception unit 155 receives, from the user, an instruction to cause the target device 200 to connect to the wireless LAN (YES in step S106), that is, when the button 91 is operated, the processing proceeds to step S107. When the instruction to cause the target device 200 to connect to the wireless LAN is not received (NO in step S106), that is, when the button 92 is operated, the processing ends.

In step S107, the transmission control unit 157 of the wireless communication device 100 performs control to transmit, to the target device 200, the setting information for establishing the wireless communication connection of the NW wireless communication system, that is, the setting information for connecting to the Wi-Fi (registered trademark) network, using the NAN connection established in step S103. For example, the transmission control unit 157 performs control to transmit the setting information to the target device 200 selected by the user as the transmission destination among the target devices 200 listed in the list. In response, the setting information acquisition unit 242 of the target device 200 acquires the setting information transmitted from the wireless communication device 100. Accordingly, the setting information is transmitted from the wireless communication device 100 to the target device 200 via the NAN connection.

Next, in step S108, the communication processing unit 243 of the target device 200 executes processing of establishing a wireless communication connection of the NW wireless communication system using the setting information received from the wireless communication device 100. That is, the communication processing unit 243 executes processing for connecting to the Wi-Fi (registered trademark) network. Accordingly, the target device 200 establishes the wireless communication connection of the NW wireless communication system, and the target device 200 participates in the wireless LAN using the access point 300.

Next, in step S109, the communication processing unit 241 of the target device 200 and the communication processing unit 153 of the wireless communication device 100 separate from the NAN cluster. The separation from the NAN cluster may be performed by only one of the target device 200 and the wireless communication device 100.

In the flowchart described above, the distance information is acquired after step S103, but may be acquired before step S103. In this case, the communication processing unit 153 may limit, using the distance information, a partner for which the NAN connection is established. That is, for example, the communication processing unit 153 may establish an NAN connection with the target device 200 whose distance is equal to or less than a predetermined threshold.

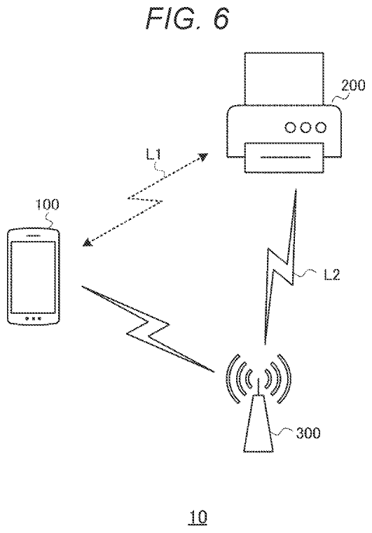

FIG. 6 is a schematic diagram showing transition of a connection state of each device in the communication system 10. As shown in FIG. 6, in step S103 described above, the wireless communication device 100 and the target device 200 establish an NAN connection L1. Then, in step S108, the target device 200 establishes a wireless communication connection L2 of the NW wireless communication system. Thereafter, in step S109, the NAN connection L1 is disconnected, and the wireless communication device 100 and the target device 200 separate from the NAN cluster.

According to the above-described embodiment, when the wireless communication device 100 and the target device 200 are not present in the same network, the setting information for connecting to the network is transmitted from the wireless communication device 100 to the target device 200, and the target device 200 participates in the network using the setting information. Therefore, even when the target device 200 is not present in the network in advance, the function of the target device 200 can be used.

Although the embodiment is described above, the present disclosure is not limited to the above-described embodiment, and can be appropriately modified without departing from the gist of the present disclosure. For example, in the above-described embodiment, the setting information is transmitted by communication using the NAN connection, and the setting information may be transmitted by communication using the discovery window. Specifically, the transmission control unit 157 of the wireless communication device 100 may transmit, by the communication using the discovery window, the service discovery frame including the setting information for participating in the network. Here, the service discovery frame including the setting information may be transmitted as any one of a Publish message, a Subscribe message, and a follow up message defined by the NAN standard. When the setting information is transmitted by the communication using the discovery window, the wireless communication device 100 may not establish the NAN connection with the target device 200. Accordingly, the setting information may be transmitted by the communication of the NAN wireless communication system, and is not limited to the transmission by the communication performed after the NAN connection is established or the transmission by the communication using the discovery window. That is, the transmission control unit 157 of the wireless communication device 100 may perform control to transmit the setting information for participating in the network to the at least one of target devices 200 using the communication of the NAN wireless communication system.

In the example described above, the program includes an instruction group (or a software code) for causing the computer to perform one or more functions described in the embodiment when the program is read by the computer. The program may be stored in a non-transitory computer-readable medium or a tangible storage medium. Examples of the computer-readable medium or the tangible storage medium include, but are not limited to, a random access memory (RAM), a read-only memory (ROM), a flash memory, a solid-state drive (SSD) or other memory technologies, a CD-ROM, a digital versatile disk (DVD), a Blu-ray (registered trademark) disk or other optical disk storages, a magnetic cassette, a magnetic tape, and a magnetic disk storage or other magnetic storage devices. The program may be transmitted on a transitory computer-readable medium or a communication medium. Examples of the transitory computer-readable medium or the communication medium include, but are not limited to, electrical, optical, acoustic, or other forms of propagating signals.

A part or all of the above-described embodiment may be described as in the following appendixes, but are not limited thereto.

### APPENDIX 1

A wireless communication device including:

a first communication processing unit configured to perform processing of executing communication of a first wireless communication system;

a target determination unit configured to determine whether a target device which is a device capable of providing a specific service is present in a network accessible by the communication of the first wireless communication system;

a second communication processing unit configured to perform processing of executing, when the target device is not present in the network, communication of a second wireless communication system, which is a communication system according to a neighbor awareness network (NAN) standard and is different from the first wireless communication system, with at least one of the target devices; and

a transmission control unit configured to perform control to transmit, to the at least one of the target devices, setting information for participating in the network using the communication of the second wireless communication system.

### APPENDIX 2

The wireless communication device according to appendix 1, in which

when transmission of the setting information is completed, the second communication processing unit is configured to separate the wireless communication device from an NAN cluster for the communication of the second wireless communication system.

### APPENDIX 3

The wireless communication device according to appendix 1, in which

when the target device that received the setting information participates in the network, the second communication processing unit is configured to separate the wireless communication device from an NAN cluster for the communication of the second wireless communication system.

### APPENDIX 4

The wireless communication device according to any one of appendixes 1 to 3, in which

the second communication processing unit is configured to search for the target device capable of providing the specific service according to the NAN standard by broadcasting an inquiry about a service.

### APPENDIX 5

The wireless communication device according to any one of appendixes 1 to 4, further including:

a distance information acquisition unit configured to acquire, for each of the at least one of the target devices, distance information indicating a distance to the wireless communication device measured according to the NAN standard, in which

the transmission control unit is configured to limit a transmission destination of the setting information based on the distance information.

### APPENDIX 6

The wireless communication device according to any one of appendixes 1 to 5, further including:

a display control unit configured to perform control to display a list of the at least one of the target devices, in which

the transmission control unit is configured to determine a transmission destination of the setting information according to an instruction to select a transmission destination from the at least one of the target devices listed in the list.

### APPENDIX 7

The wireless communication device according to appendix 6, further including:

a distance information acquisition unit configured to acquire, for each of the at least one of the target devices, distance information indicating a distance to the wireless communication device measured according to the NAN standard, in which

the display control unit is configured to perform control to further display the distance information of each of the at least one of the target devices in the list.

### APPENDIX 8

A method for controlling a wireless communication device, the method including:

performing processing of executing communication of a first wireless communication system;

determining whether a target device which is a device capable of providing a specific service is present in a network accessible by the communication of the first wireless communication system;

performing processing of executing, when the target device is not present in the network, communication of a second wireless communication system, which is a communication system according to an NAN standard and is different from the first wireless communication system, with at least one of the target devices; and

performing control to transmit, to the at least one of the target devices, setting information for participating in the network using the communication of the second wireless communication system.

### APPENDIX 9

A non-transitory computer-readable storage medium storing a program, the program causing a computer to execute:

a first communication processing step of performing processing of executing communication of a first wireless communication system;

a target determination step of determining whether a target device which is a device capable of providing a specific service is present in a network accessible by the communication of the first wireless communication system;

a second communication processing step of performing processing of executing, when the target device is not present in the network, communication of a second wireless communication system, which is a communication system according to an NAN standard and is different from the first wireless communication system, with at least one of the target devices; and

a transmission control step of performing control to transmit, to the at least one of the target devices, setting information for participating in the network using the communication of the second wireless communication system.

What is claimed is:

1. A wireless communication device comprising:
a first communication processor configured to perform processing of executing communication of a first wireless communication system;
a target determination unit configured to determine whether a target device which is a device configured to provide a specific service is present in a network accessible by the communication of the first wireless communication system;
a second communication processor configured to perform processing of executing, when the target device is not present in the network, communication of a second wireless communication system, which is a communication system according to a neighbor awareness network (NAN) standard and is different from the first wireless communication system, with at least one of the target devices; and
a transmission controller configured to perform control to transmit, to the at least one of the target devices, setting information for participating in the network using the communication of the second wireless communication system.

2. The wireless communication device according to claim 1, wherein
when transmission of the setting information is completed, the second communication processor is configured to separate the wireless communication device from an NAN cluster for the communication of the second wireless communication system.

3. The wireless communication device according to claim 1, wherein
when the target device that received the setting information participates in the network, the second communication processor is configured to separate the wireless communication device from an NAN cluster for the communication of the second wireless communication system.

4. The wireless communication device according to claim 1, wherein
the second communication processor is configured to search for the target device configured to provide the specific service according to the NAN standard by broadcasting an inquiry about a service.

5. The wireless communication device according to claim 1, further comprising:
a distance information acquisition unit configured to acquire, for each of the at least one of the target devices, distance information indicating a distance to the wireless communication device measured according to the NAN standard, wherein
the transmission controller is configured to limit a transmission destination of the setting information based on the distance information.

6. The wireless communication device according to claim 1, further comprising:
a display controller configured to perform control to display a list of the at least one of the target devices, wherein
the transmission controller is configured to determine a transmission destination of the setting information according to an instruction to select a transmission destination from the at least one of the target devices listed in the list.

7. The wireless communication device according to claim 6, further comprising:
a distance information acquisition unit configured to acquire, for each of the at least one of the target devices, distance information indicating a distance to the wireless communication device measured according to the NAN standard, wherein
the display controller is configured to perform control to further display the distance information of each of the at least one of the target devices in the list.

8. A method for controlling a wireless communication device, the method comprising:
performing processing of executing communication of a first wireless communication system;
determining whether a target device which is a device configured to provide a specific service is present in a network accessible by the communication of the first wireless communication system;
performing processing of executing, when the target device is not present in the network, communication of a second wireless communication system, which is a communication system according to an NAN standard and is different from the first wireless communication system, with at least one of the target devices; and
performing control to transmit, to the at least one of the target devices, setting information for participating in the network using the communication of the second wireless communication system.

9. A non-transitory computer-readable storage medium storing a program, the program causing a computer to execute:
a first communication processing step of performing processing of executing communication of a first wireless communication system;
a target determination step of determining whether a target device which is a device configured to provide a specific service is present in a network accessible by the communication of the first wireless communication system;
a second communication processing step of performing processing of executing, when the target device is not present in the network, communication of a second wireless communication system, which is a communication system according to an NAN standard and is different from the first wireless communication system, with at least one of the target devices; and
a transmission control step of performing control to transmit, to the at least one of the target devices, setting information for participating in the network using the communication of the second wireless communication system.
